(19) United States
(12) Patent Application Publication
(10) Pub. No.: US 2011/0198298 A1
(43) Pub. Date: Aug. 18, 2011

(54) FLOATING CAPILLARY FILTER AND METHOD

(76) Inventors: John W. Macpherson, JR., Bothell, WA (US); Karl E. Bruegeman, Everett, WA (US)

(21) Appl. No.: 12/913,607

(22) Filed: Oct. 27, 2010

Related U.S. Application Data
(60) Provisional application No. 61/255,350, filed on Oct. 27, 2009.

(51) Int. Cl. C02F 1/00

(52) U.S. Cl. 210/747.6; 210/170.05

(57) ABSTRACT

Systems and method for floating a capillary filter system in a fluid and filtering the fluid via capillary action are described. The floating filter system may include one or more floatation devices configured to provide suitable buoyancy to cause the floating filter system to float within the fluid to be filtered.

### CROSS-REFERENCE TO RELATED APPLICATION

The present application claims the benefit of Provisional Application No. 61/255,350, filed Oct. 27, 2009, incorporated herein by reference in its entirety for all purposes.

### TECHNICAL FIELD

Embodiments of the present disclosure relates generally to methods and devices for separating liquids and solids, including filtering fluids using capillary action.

### BACKGROUND

Stormwater, which runs off land cleared of vegetation, such as construction sites, mining projects, forestry, dredging projects, etc., often has a high degree of contamination. In certain situations, stormwater may be directed to holding ponds to limit contamination of natural water systems. Due to stringent water quality standards set at both the State and Federal level, stormwater may require treatment in holding ponds before being released back into water systems, such as streams, rivers, lakes, or marine environment. Traditional treatments generally consist of gravity settling treatments and may require high-pressure pumps for pumping fluid to be filtered. Furthermore, traditional treatments generally require close monitoring and frequent maintenance, such as filter cleaning and/or replacement.

Recent methods for treating water have included aggregation treatment in combination with filtering the water. Chemical treatments typically include adding a coagulant and/or flocculent to the water to cause particles in the water to aggregate. Chemically treating the water before filtering may decrease or eliminate the need for high-pressure pumps; however, when used in combination with gravity settling filters, such filtering may still require close monitoring and frequent maintenance.

More recently, chemically treated water has been filtered in combination with capillary filtration. U.S. patent application Ser. No. 11/564,004 filed on Nov. 28, 2006, now U.S. Pat. No. 7,749,391, describes such a capillary filtration process for chemically treated water and is herein incorporated by reference in its entirety for all purposes. There still exists a need, however, for a capillary filtration system that is designed to accommodate water treatment systems having variable water levels.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with aspects of the present disclosure, a method of filtering a fluid in a reservoir by capillary action is provided. The method may include floating a receptacle in the fluid. The receptacle may have an inlet positioned above a top surface of the fluid. The method may further include positioning a filter medium having a first portion and a second portion. The first portion of the filter media may be positioned in the reservoir, and the second portion of the filter media may be positioned in the receptacle, such that at least some of the fluid in the reservoir migrates into the receptacle.

In accordance with aspects of the present disclosure, a floating capillary filter system is provided. The floating capillary filter system may be configured to float in a fluid to be filtered. The floating capillary filter system may include at least one receptacle, a filter medium, and a floatation device. The at least one receptacle may have an inlet and an outlet and define a channel for receiving fluid. The filter medium may have a first portion and a second portion. The first portion of the filter medium may be disposed in the channel of the at least one receptacle and the second portion of the filter medium may be adjacent an outer surface of the receptacle. The floatation device may be coupled to the at least one receptacle.

In accordance with aspects of the present disclosure, a system for filtering a body of water is provided. The system may include one or more partitions, a pump, a treatment component, and a floating filter system. The one or more partitions may be configured to at least partially separate a first portion of the body of water from a second portion of the body of water. The pump may be configured to pump water from the first portion of the body of water and to provide the pumped water to the second portion of the body of water. The treatment component may be configured to add a coagulant and/or flocculent to the water pumped from the first portion of the body of water before the pump provides the water to the second portion of the body of water. The floating filter system may be configured to float on a surface of the second body of water and to filter the second body of water via capillary action.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a top isometric view of a floating filter system in accordance with an embodiment of the present disclosure;

FIG. 2 is a schematic isometric close-up view of box 2 in FIG. 1;

FIG. 3 is a schematic cross-sectional view of the floating filter system of FIG. 1 floating in a reservoir;

FIG. 4 is a schematic cross-sectional view of a portion of the floating filter system of FIG. 1;

FIG. 5 is a schematic cross-sectional view of a portion of the floating filter system of FIG. 1 in accordance with another embodiment of the present disclosure;

FIG. 6 is a schematic cross-sectional view of the filter medium in the floating filter system of FIG. 1;

FIG. 7 is a schematic cross-sectional view of a portion of the floating filter system of FIG. 1 including a cap in accordance with another embodiment of the present disclosure;

FIG. 8 is schematic cross-sectional view of the floating filter system of FIG. 1 floating in a partially contained natural body of water in accordance with another embodiment of the present disclosure;

FIG. 9 is a schematic cross-sectional view of a floating filter system in accordance with another embodiment of the present disclosure.

### DETAILED DESCRIPTION

The detailed description set forth below in connection with the appended drawings where like numerals reference like elements is intended only as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Accordingly, various changes can be made therein without departing from the spirit and scope of the disclosure. Similarly, any steps described herein may be interchangeable with other steps, or combinations of steps, in order to achieve the same or substantially similar result.

The following discussion proceeds with reference to examples of floating filter systems and methods. Generally described, the floating filter systems and methods described herein aim to float a capillary filter within a fluid to be filtered so as to allow for a variable fluid level.

By floating the filter system within the fluid to be filtered, the capillary filter is able to filter the fluid with the lowest concentration of particles. In that regard, aggregated particles and other contaminants may settle in the fluid as a result of gravity causing a greater concentration of particles at the depth of the fluid and the lowest concentration of the particles at the top surface of the fluid. In some embodiments described herein, the fluid may be treated to cause particles within the fluid, such as contaminants in a turbid fluid, to aggregate and form aggregated particles.

By filtering the fluid with the lowest concentration of particles, filter media used to filter the fluid may stay clean for longer periods of time. Thus, the filter system may require less maintenance than traditional filters. Furthermore, by floating the floating filter system in the fluid to be filtered, any fluid body may be easily filtered.

Although shown and described for filtering contaminated fluids, such as stormwater, it should be appreciated that the methods and systems described herein may be applied to other industries, for example, waste management, drinking water, food processing, etc.

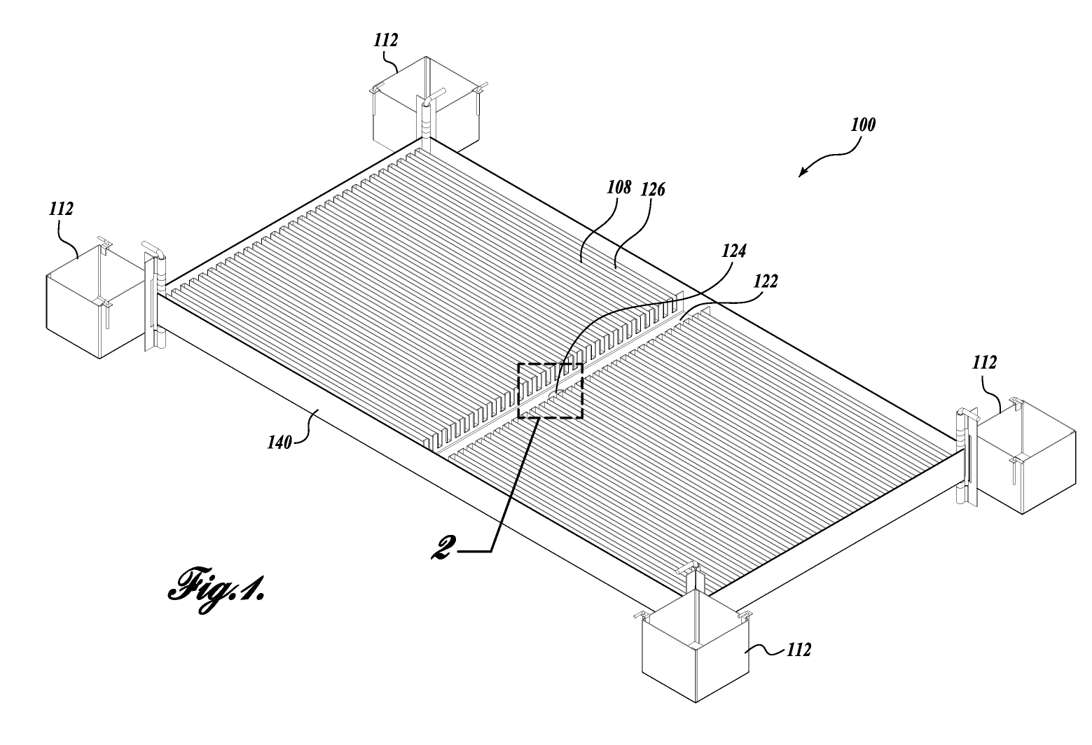

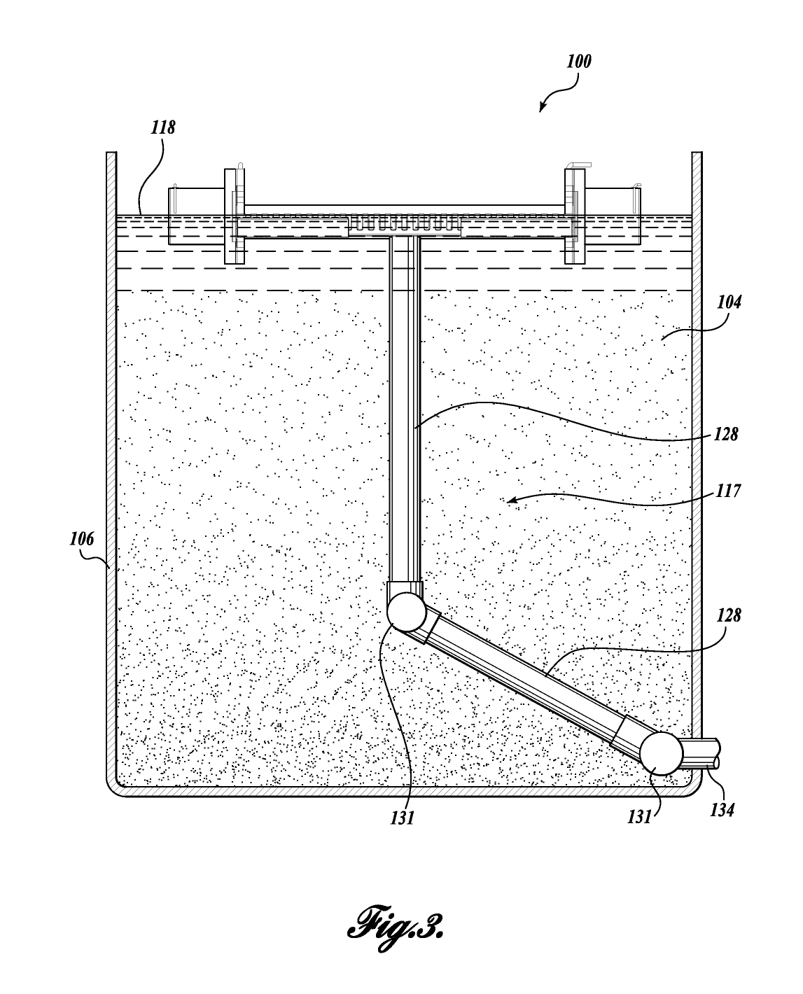

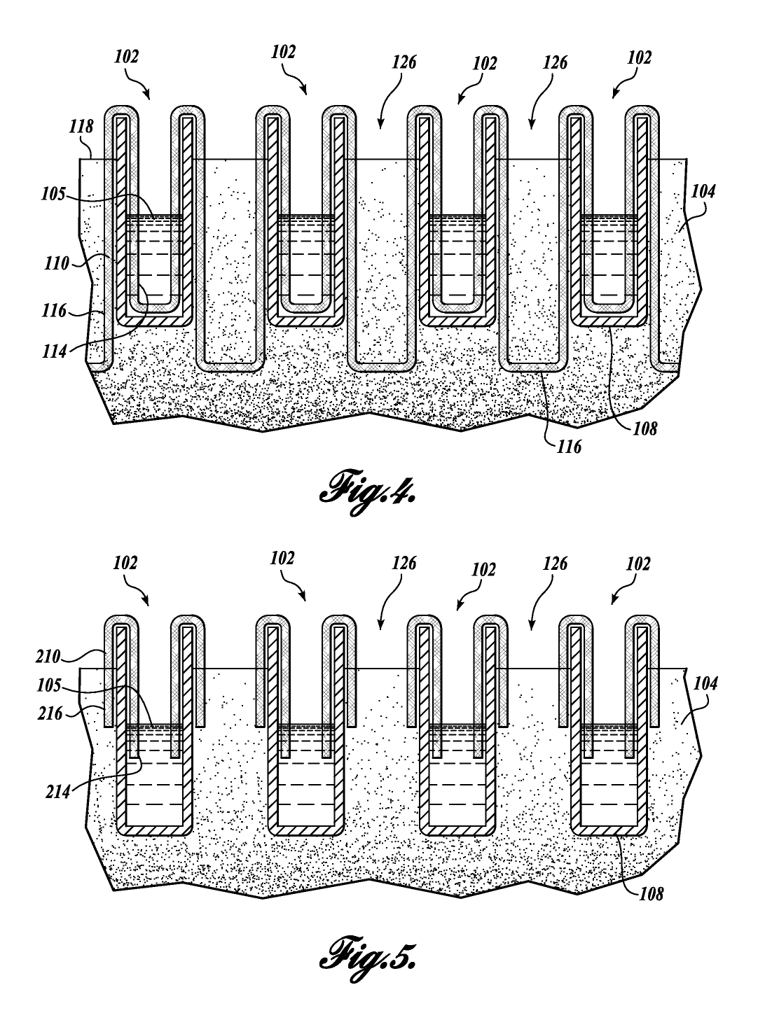

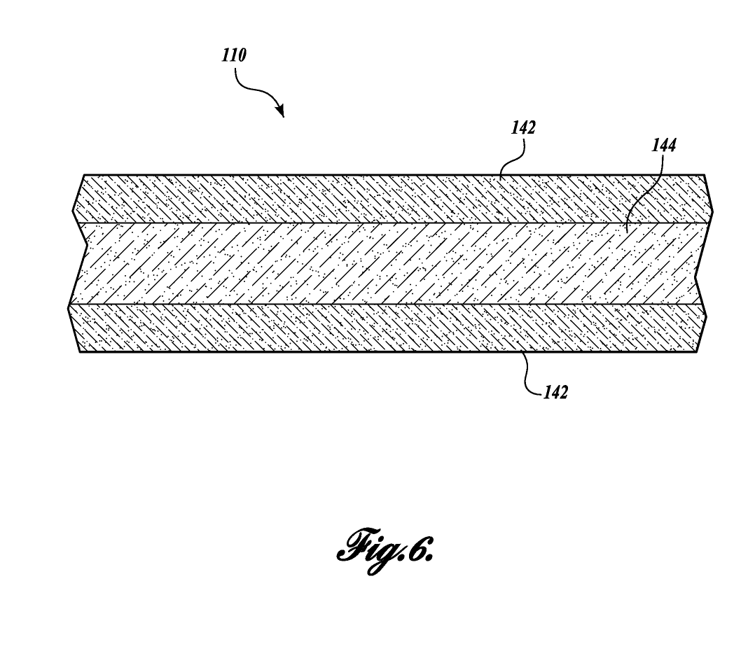

A floating filter system 100 in accordance with one embodiment of the present disclosure may be best understood by referring to FIGS. 1-5. The floating filter system 100 includes at least one filtration element 102 configured to filter a fluid, such as fluid 104 illustrated in FIG. 3, via capillary action. In the illustrated embodiment, the floating filter system 100 includes a plurality of filtration elements 102 coupled to a frame 140. Each respective filtration element 102 is spaced apart from an adjacent filtration element 102 defining an opening 126 therebetween. As seen in FIGS. 4 and 5, fluid 104 to be filtered is located in the system 100 between adjacent filtration elements 102.

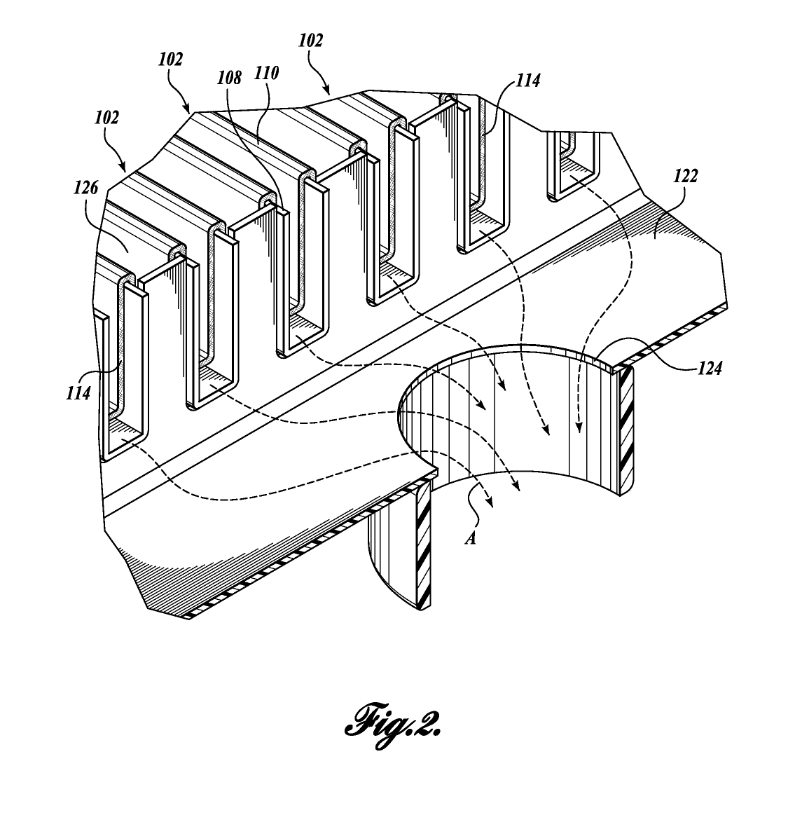

As seen in FIG. 2, each of the filtration elements 102 includes a receptacle 108 and one or more filter medium 110. Each receptacle 108 includes an inlet and an outlet and defines a channel for receiving fluid. In the illustrated embodiment, each receptacle 108 defines a U-shaped channel. In the illustrated embodiment, the inlet is positioned proximate a top surface 118 of a fluid 104 to be filtered, and the outlet extends along a side of the receptacle 106 and opens into a collector 122. In that regard, fluid may flow from the outlet of the receptacles 108 to the collector 122, as shown by arrows A. In an alternative embodiment, the receptacles 108 may be configured at an incline toward the collector 122 to encourage fluid flow from the receptacles 108 to the collector 122.

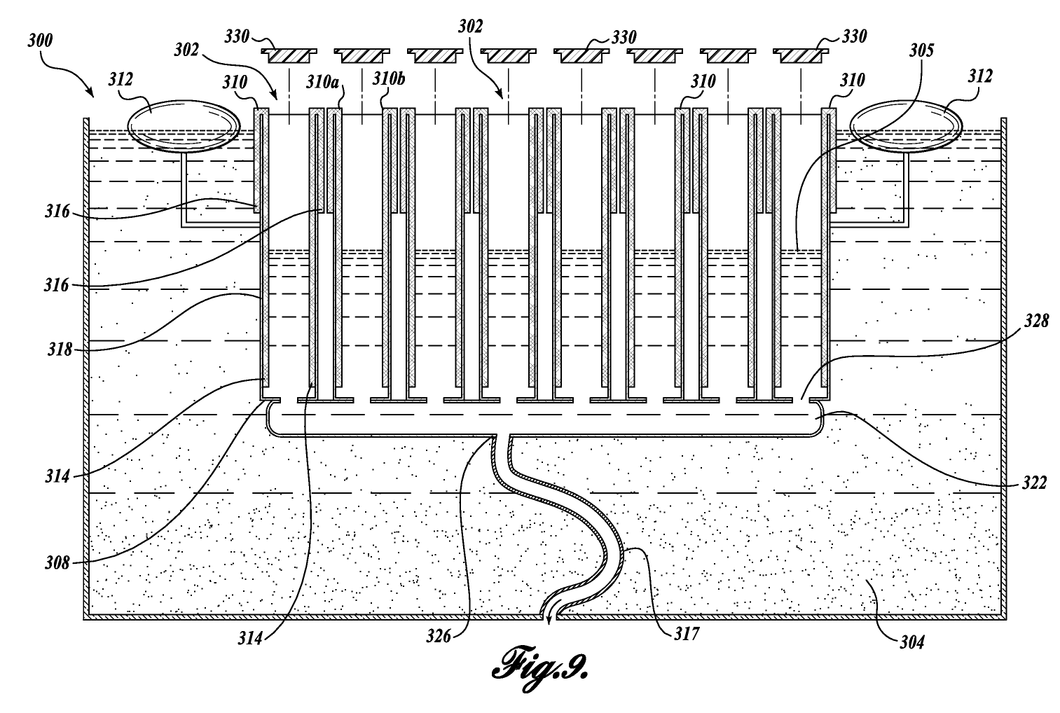

As is best illustrated in FIG. 4, the fluid 104 to be filtered is an aqueous solution that may be contained in a reservoir 106, which may be a man-made environment (see, for example, FIG. 3), or a naturally existing body (see, for example, FIG. 8).

The filter medium 110 is configured to transfer the fluid 104 from the reservoir 106 to the one or more receptacles 108. In that regard, the filter medium 110 may be any porous material configured to allow fluid to pass through the pores of the filter medium 110 via capillary action. The speed and volume of fluid that travels along the filter medium 110 is the result of various properties, such as surface tension, wetting, cohesion, adhesion and/or viscosity of the fluid, as well as the properties of the filter medium 110.

Referring to FIG. 4, the filter medium 110 has a first portion 114 and a second portion 116. The first portion 114 of the filter medium 110 may extend into the channel of the receptacle 108. The second portion 116 of the filter medium 110 may extend into the opening 126 defined by two adjacent receptacles 108. Therefore, when the system 100 is floating in a reservoir 106, the second portion 116 of the filtration medium 110 extends into the fluid 104 to be filtered. In that regard, the first portion 114 of the filtration medium 110 is generally disposed near an inner surface of the receptacle 108, and the second portion 116 of the filtration medium 110 is disposed near an outer surface of the receptacle 108.

To assist filtration by capillary action, the first portion 114 of the filter media 110 is typically positioned below a top surface 118 of the fluid 104. As the fluid 104 from the reservoir 106 travels through the filter media 110, the fluid is filtered and transferred to the inside of the receptacle 108. That is, filtered fluid 105 that passes through the filter media 110 from the second portion 116 to the first portion 114 may separate from the filter media 110 and collect in the receptacle 108.

As seen in the illustrated embodiment of FIG. 4, the filter medium 110 is a single continuous filter medium having alternating first and second portions 114 and 116. In this embodiment, the continuous filter medium 110 may be used to support filtration by capillary action. In particular, fluid may migrate from the second portions 116 of the filter medium 110 that extends into the fluid 104 to the first portion 114 of the filter media 110 that is located in an adjacent receptacle 108. The filtered fluid 105 may then exit the filter media 110 and collect in the corresponding receptacle 108.

Alternatively, and as best illustrated in FIG. 5, the filter medium may include a plurality of discrete filter media 210. Each of the plurality of discrete filter media 210 may include a first portion 214 or end and a second portion 216 or end. The first portion 214 may be disposed in a corresponding receptacle 108. The second portion 216 may be disposed in the openings 126 and immersed in the fluid 104 to be filtered. As is illustrated in FIG. 5, each of the receptacles 108 may comprise a plurality of filter media 210. However, it should be understood that each receptacle 108 may include as few as one filter medium 210.

The filter medium, whether continuous or non-continuous, includes a plurality U-shaped sections, each section having first and second leg portions. As one non-limiting example, the filter medium may be flexible so as to drape over the walls of the receptacle. As another non-limiting example, the filter media make be preformed so as to be placed over the walls of the receptacle.

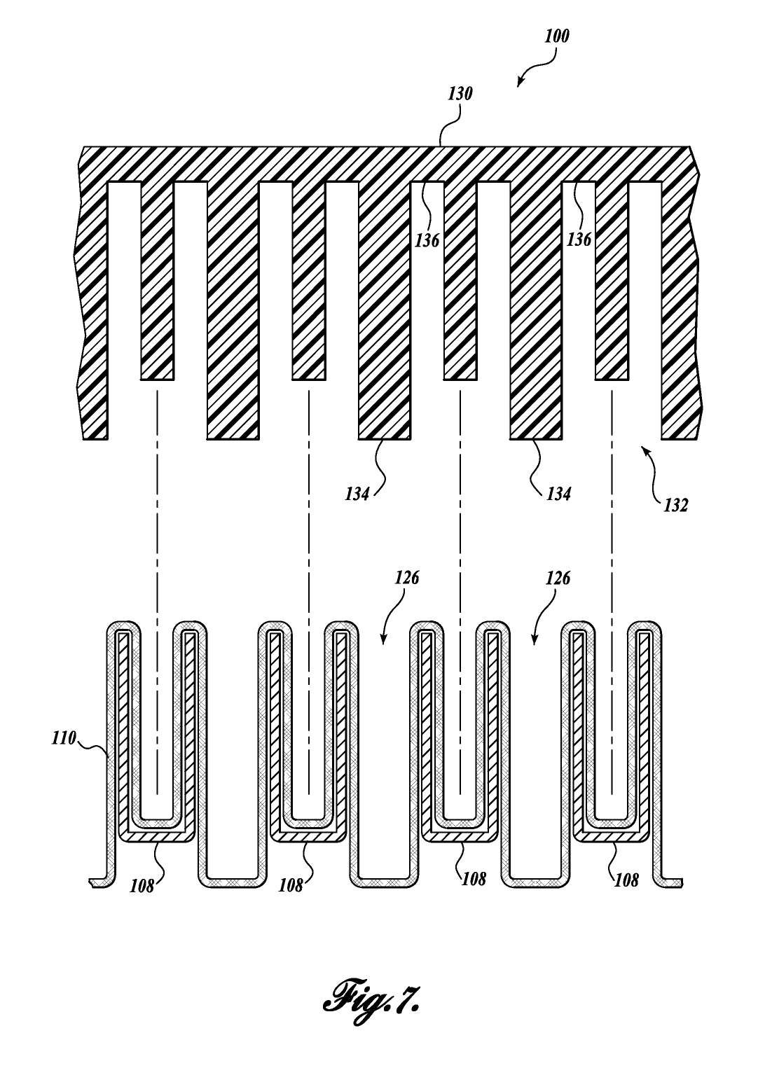

As described above, the filter medium 110 may be any material sufficient to allow filtration of a fluid via capillary action. As non-limiting examples, suitable filter media may include porous materials, such as polyester, polypropylene, cotton, wool, or a mixture thereof. For instance, in one example the filter medium includes a nonwoven, melt-blown polyester. The filter medium may be one or more layers of a single material or of various materials. Turning now to FIG. 6, a schematic cross-sectional view of the filter medium 110 in the floating filter system 100 of FIG. 1 will now be described. The filter medium 110 comprises a multi-layered filter medium having first and second outside layers 142 surrounding a middle layer 144. In one embodiment, the first and second outside layers 142 comprises a polyester felt and the middle layer 144 comprises a polyester batting, such as a lightweight polyester batting.

As indicated above, the filter system 100 is designed to accommodate variable fluid levels in the reservoir 106 so that fluid level does not affect the efficiency of the system. As seen in FIGS. 1 and 3, the filter system 100 is configured to float within the fluid 104 to be filtered via one or more floatation devices 112. As is illustrated, the one or more floatation device 112 are coupled to the frame 140.

The floatation devices 112 may comprise any shape or material configured to displace fluid to allow the floating filter system 100 to float in or on the fluid to be filtered. Although FIG. 1 illustrates floatation devices 112 as open chambers components, it is to be understood that enclosed floatation devices may be used. In another embodiment, one or more floatation devices are formed integral with the frame 140 such that the shape and size of the frame 140 causes the floating filter system 100 to float in or on a surface of a fluid. As will be clear to those skilled in the art, any number of floatation devices 112, including one, may be used, and the floatation devices may be located in any position within or around the floating filter system 100.

To achieve flotation, the positioning of the floatation devices 112 is adjustable relative to the frame 140. In particular, the floatation devices 112 may be adjusted to move above, below, or in the same plane as a plane defined by a central axis of the frame 140. In some embodiments, by adjusting the position of the floatation devices 112 relative to the frame 140, the position of each receptacle 108 relative to the fluid 104 to be filtered may be adjusted. This may allow an adjustment of the speed at which fluid migrates through the filter fabric. In addition, adjusting the position of the of the floatation devices 112 relative to the frame 140 may facilitate various filter media path lengths.

Any known methods for floating an object may be used for the one or more floatation devices 112. In some embodiments, the floatation devices 112 are adjustable to provide sufficient buoyancy for the floating filter system 100 for various fluids densities. For instance, a size and shape of the one or more floatation devices 112 may be adjusted to adjust the buoyancy of the floating filter system 100, or a height of the one or more floatation devices 112 may be adjusted relative to a top surface of the receptacle 108.

The one or more floatation devices 112 may be configured to position the receptacle 108 relative to a top surface 118 of the fluid 104 to be filtered. In one embodiment, the inlet of the receptacle 108 is positioned within a few inches of the top surface 118 of the fluid 104. In another embodiment, the inlet of the receptacle 108 is positioned within one inch from the top surface 118 of the fluid 104. In some examples, the floating filter system 100 may be further weighted to adjust the position of the opening of the receptacle 108 relative to the top surface 118 of the fluid 104.

The filtered fluid 105 may exit each of the receptacles 108 via a corresponding receptacle outlet, and the filtered fluid 105 may be received in the collector 122. As is best illustrated in FIGS. 2 and 3, the collector 122 may be in fluid communication with an under drain assembly 117 via a collector outlet 124. The under drain assembly 117 may be configured to allow the filtered fluid 105 in the collector 122 to drain, for example, into a collection reservoir (not shown). The under drain assembly 117 may be flexible to accommodate changes in position of the floating filter system 100 relative to a reservoir outlet of the reservoir 106 as the floating filter system 100 drains the filtered fluid 105 into the collection reservoir.

As is illustrated in FIG. 3, the under drain assembly 117 may include a plurality of conduits 128 coupled via flexible or articulated joints 131. In particular, a first end of a first conduit 128 is in fluid communication with the collector outlet 124. A second end of the first conduit 128 may be in fluid communication with a first end of a second conduit 128 via a joint 131. A second end of a second conduit 128 is in fluid communication with an under drain assembly outlet 134 via a joint 131. The under drain assembly outlet 134 extends through an opening of the reservoir 106. Filtered fluid 105 is therefore able to exit the floating filter system 100 by traveling through the conduits 128. The filtered fluid 105 exits the conduits 128 at under drain assembly outlet 134 and may be collected in a collection reservoir (not shown).

As fluid is filtered and exits through the under drain assembly outlet 134, the level of fluid 104 remaining in the reservoir 106 will decrease. As the level of the fluid 104 in the reservoir 106 decreases, the height of the floating filter system 500 relative to the under drain assembly outlet 134 decreases. The one or more joints 131 provides the flexibility to allow the conduits 128 to move as the relative height of the floating filter system 100 moves. Alternatively, a single conduit made of flexible material, such as flexible plastic, may be used (see, for example, FIG. 9). The single flexible conduit may be coupled at a first end to the collector outlet 124 of the collector 122 and at a second end to the under drain assembly outlet 124 of the reservoir 106.

Prior to beginning filtration by capillary action, the fluid 104 may be treated so that the particles aggregate. For instance, in some cases the fluid 104 may contain contaminates, such as submicron particles floating therein, and thus may appear cloudy or turbid. In some examples, a coagulant and/or a flocculent, such as chitosan, may be added to the fluid 104. The coagulant or flocculent may be configured to cause small particles within the fluid 104 to aggregate to form aggregated particles.

It should be appreciated, however, that in some applications, the fluid 104 may have aggregated particles without requiring chemical or other treatment. Such particles may be uniformly dispersed throughout the fluid or they may be dispersed nonuniformly, for example, in a gradient, such that there are more particles at the bottom of the fluid than on the top surface of the fluid. Embodiments of the present disclosure that float the filtration element may have improved efficiency over non-floating systems because the portion of the fluid 104 that is being filtered is typically the top fluid or the cleanest fluid in the reservoir 106.

In general, aggregated particles are of sufficient size to prevent migration of the aggregated particles via the filter media 110. In some embodiments the aggregated particles formed in the fluid by the chemical treatment are larger than the pores in the filter media 110, therefore inhibiting the migration of the aggregate particles through the filter media 110. The fluid 104, however, is still able to migrate through the filter media 110 via capillary action. As a result, clean fluid migrates to the receptacle 108 and fluid containing particulate matter is maintained in the reservoir 106.

It is to be understood by those skilled in the art that in some cases not all particles in the fluid 104 will be prevented from migrating through the filter media 110. In some cases, the receptacle 108 receives fluid having some particulate matter. As described above, the majority of the aggregated particles and other contaminants in the fluid may settle towards the bottom of the reservoir 106 due to their density relative to the fluid 104, thereby resulting in a portion of the fluid 104 having the smallest concentration of aggregated particles to remain towards the top of the reservoir 106. This settling action improves the efficiency of the system, because the portion of the fluid 104 that is being filtered is the cleanest fluid in the reservoir 106.

The amount of coagulant or flocculent added may be any amount suitable to form particles that are sufficiently large to prevent transport via capillary action or sufficiently larger than the pores of the filter media 110. In one example, 0.5 to 1.5 grams of chitosan may be added to for each five gallons of water in the reservoir 106. In general, once the coagulant and/or the flocculent has been added to the fluid 104, the coagulant and/or flocculent is given time to react with the particles in the fluid 104. The fluid 104 may, in some examples, be mixed to distribute the coagulant throughout the fluid 104.

In use, floating filter system 100 may be used to filter a fluid in a reservoir by capillary action. An inlet of the one or more receptacles 108 of the floating filter system 100 is positioned above a top surface of the fluid 104 to receive filtered fluid. In that regard, the filtered fluid is filtered through a filter medium 110 having a first portion positioned within the receptacle 108 and a second portion positioned in the reservoir 104. Filtered fluid 105 migrates through the filter medium 110 from the reservoir 104 to the receptacle 108. Because particulate matter generally cannot migrate through the filter medium 110, the clean fluid travels from the reservoir 104 to the receptacle.

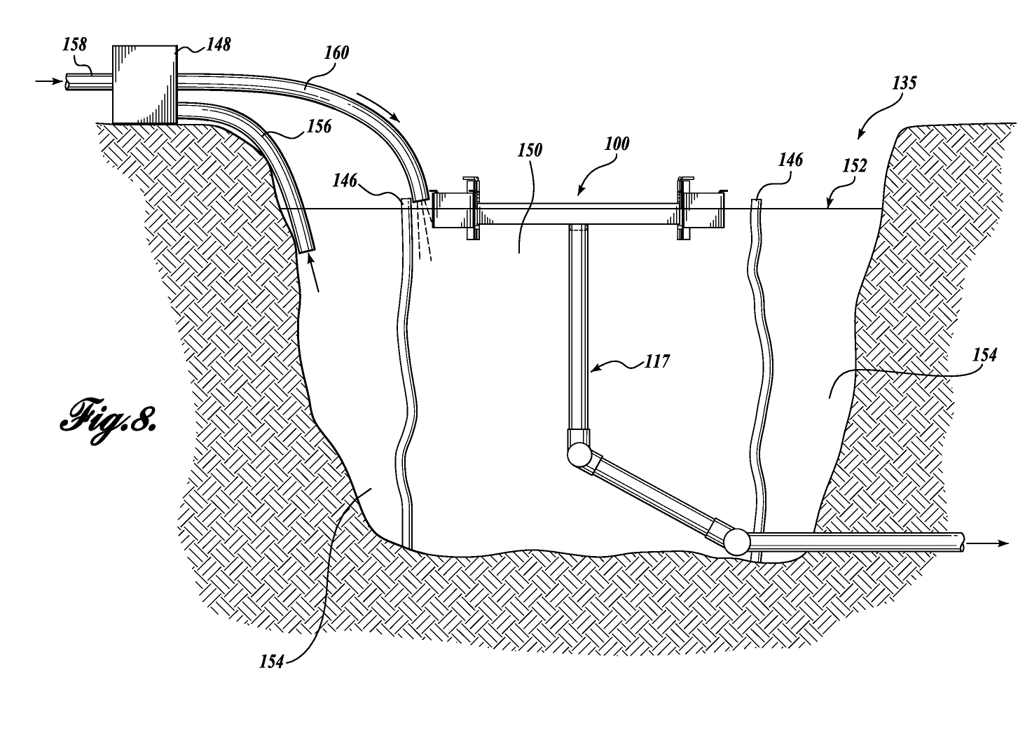

As is best illustrated in FIG. 7, the floating filter system 100 may further include a cap 130 configured to hold the filter medium 110 in position and/or to prevent debris and dirty water from contaminating the filtered water 105 in a corresponding receptacle 108. As is illustrated in FIG. 7, the cap 130 may include a plurality of alternating peaks 134 and valleys 136. The alternating peaks 134 correspond to the channels of the receptacles 108 and the openings 126 defined by adjacent receptacles 108, and the alternating valleys 136 correspond to side walls of the receptacles 108 such that when the cap 130 is positioned on the filter system 100, the peaks 134 are located in the receptacles 108 and openings 126.

In some embodiments, the cap 130 may be used to position the filter media 110 within the respective receptacles 108 and openings 126. For instance, in one embodiment the filter medium 110 may be first positioned along an under surface 132 of the cap 130, such as along the peaks 134 and valleys 136, prior to positioning the cap 130 over the corresponding receptacles 108 and openings 126. In another embodiment, the filter medium 110 may be first positioned over the receptacles 108 and openings 126, and the peaks 134 of the cap 130 may be used to cause the filter medium 110 to extend into corresponding openings 126 and receptacles 108. In some embodiments, the cap 130 will not compress the filter media 110 against a corresponding surface of a receptacle 108. Rather, the cap 130 may loosely fit against the filter media 110 while providing sufficient friction to retain the cap 130 in position without inhibiting capillary filtration via the filter media 110. In an alternative embodiment, individual caps may be placed over each channel of the receptacles 108 (see, for example, FIG. 9.

FIG. 8 is a schematic cross-sectional illustration of a system 135 comprising a floating filter system 100 used in a partially contained body of water in accordance with one embodiment of the present disclosure. The system 135 includes partitions 146 to at least partially separate a first portion 150 of a body of water 152 from a second portion 154 of the body of water. 152 In one embodiment, the body of water 152 is a natural body of water, such as a pond. The floating filter system 100 may be configured to filter the first portion 150 of the body of water 152 and to drain the filtered fluid 105 as via the under drain assembly 117 as described in reference to FIGS. 1-5.

In the illustrated embodiment, the first portion 150 of the body of water 152 may be treated by a treatment pump 148. The treatment pump 148 includes a first inlet 156 configured to receive water from the second portion 154 of the body of water 152. The treatment pump 148 includes a second inlet 158 configured to receive a coagulant and/or flocculent, such as chitosan, for treating the water entering the treatment pump 148 via the first inlet 156. The treatment pump 148 may be configured to mix the water received via the first inlet 156 with the coagulant and/or flocculent received via the second inlet 158 to form a mixture and provide the mixture to the first portion 150 of the body of water 152 via a treatment pump outlet 160. In one embodiment, the treatment pump 148 may be configured to mix the water received via the first inlet 156 with the coagulant and/or flocculent for a particular amount of time or until a number of the particles in the water combined into aggregated particles to form treated water. In another embodiment, the treatment pump 148 provides the mixture to the first portion 150 without a delay. Although the treatment pump 148 is depicted as a single unit, the treatment portion may be distinct from the pump portion. In that regard, the treatment portion may be configured to provide the coagulant and/or flocculent to fluid pumped by the pump portion. In an alternative embodiment, the first portion 150 of the body of water 152 is not treated via the treatment pump 148. Rather, the first portion 150 is separated from the second portion 154 via partitions 146. The first portion 150 may be treated by any method described herein and filtered using the floating filter system 100.

FIG. 9 is a cross-sectional illustration of a floating filter system 300 in accordance with another embodiment of the disclosure. The floating filter system 300 is substantially identical in components and operation as the previously described embodiment, except for differences regarding portions of the filter element, collector, floatation devices, and cap, which will be described in greater detail below. For clarity in the ensuing descriptions, numeral references of like elements of the floating filter system 100 are similar, but in the 300 series for the illustrated embodiment.

The floating filter system 300 includes a plurality of filter elements 302. Each of the filter elements 302 includes a receptacle 308 and one or more filter medium 310. As is illustrated in FIG. 9, each filtration element 302 includes a first filter medium 310a and a second filter medium 310b. A first end 314 of each filter medium 310 extends in a corresponding receptacle 308 and a second end 316 of each filter medium extends into a fluid 304 to be filtered. As will be clear to those skilled in the art, each filtration element 302 may include any number of filter medium 310, such as one filter medium or more than two filter media. Furthermore, the filter media 310 may be continuous as is described in reference to FIG. 4.

As the fluid 304 travels through the filter medium 310 and is collected in each respective receptacle 308, the filtered fluid 305 may drain from the receptacles 308 into a collector 322 via corresponding receptacle outlets 328. The collector 322 may include a collector outlet 326. The collector outlet 326 may be in fluid communication with an under drain assembly 317 to allow the filtered fluid 305 in the collector 322 to drain, for example, to a collection reservoir (not shown).

The floating filter system 300 further includes floatation devices 312 configured to displace the fluid 304 and cause the floating filter system 300 to float. The floatation devices 312 be any shape or material configured to cause the floatation. As is illustrated in FIG. 9, the floatation devices 312 may be enclosed. In addition, the floatation devices 312 may be replaced with the floatation devices 112 of FIG. 1.

Individual caps 330 may be configured to be positioned over the openings 302 of each receptacle 308. The caps 330 may be configured to hold the filter medium 310 in place and/or to prevent debris or dirty water from entering the receptacles 308. In an alternative embodiment, a single cap may be used to cover each receptacle 308.

Any of the receptacle outlets and collector outlets referred to herein may include a valve (not shown) configured to selectively open and close the corresponding outlet. In that regard, the valve may be configured to selectively place corresponding receptacles in fluid communication with a corresponding collector and to selectively place a collector in fluid communication with a corresponding under drain assembly. The valve may be a hydraulic valve configured to open in response to a particular amount of fluid force being applied thereto.

As will be clear to those skilled in the art the floating filter systems described herein may be adapted for use in any number of reservoirs, such as natural bodies of water or manufactured bodies of water. In many embodiments, the floating filter systems will likely require minimal maintenance. For instance, the filter media described herein may be easily removed from the floating filter system for replacement or cleaning.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the claimed subject matter.

The embodiments of the disclosure in which an exclusive property or privilege is claimed are defined as follows:

1. A method of filtering a fluid in a reservoir by capillary action, the method comprising:
floating a receptacle in the fluid, wherein the receptacle has an inlet positioned above a top surface of the fluid; and
positioning a filter medium having a first portion and a second portion, wherein the first portion of the filter media is positioned in the reservoir and the second portion of the filter media is positioned in the receptacle, such that at least some of the fluid in the reservoir migrates into the receptacle.

2. The method of claim 1, wherein the fluid that migrates into the receptacle separates from the filter media and is collected in the receptacle.

3. The method of claim 2, further comprising draining the fluid collected in the receptacle.

4. The method of claim 1, wherein the first portion of the filter medium is a first end of the filter medium and the second portion of the filter medium is a second end of the filter medium.

5. The method of claim 1, further comprising floating a plurality of receptacles in the fluid, each of the plurality of receptacles spaced apart from an adjacent receptacle defining an opening therebetween.

6. The method of claim 5, wherein the filter medium is a continuous filter medium having alternating first and second portions.

7. The method of claim 6, wherein the first portions of the filter medium are positioned in a respective receptacle and the second portions are positioned in a respective opening between two adjacent receptacles.

8. The method of claim 5, wherein the filter medium comprises a plurality of discrete filter media.

9. The method of claim 1, further comprising causing at least some particles within the fluid to form an aggregated clump of particles.

10. The method of claim 1, wherein the filter medium is a multi-layer porous material comprising polyester or polypropylene.

11. A floating capillary filter system configured to float in a fluid to be filtered, the floating capillary filter system comprising:
at least one receptacle having an inlet and an outlet and defining a channel for receiving fluid;
a filter medium having a first portion and a second portion, the first portion of the filter medium disposed in the channel of the at least one receptacle and the second portion of the filter medium adjacent an outer surface of the receptacle; and
a floatation device coupled to the at least one receptacle.

12. The floating capillary filter system of claim 11, wherein the first portion of the filter medium is a first end of the filter medium and the second portion of the filter medium is a second end of the filter medium.

13. The floating capillary filter system of claim 11, further comprising a plurality of receptacles, each receptacle having an inlet and an outlet and a defining a channel for receiving fluid, each receptacle spaced apart from an adjacent receptacle defining an opening therebetween.

14. The floating capillary filter system of claim 13, wherein the filter medium is a continuous filter medium having alternating first and second portions.

15. The floating capillary filter system of claim 13, wherein the filter medium is a plurality of discrete filter media.

16. The floating capillary filter system of claim 13, further comprising a collection channel in fluid communication with each of the outlets of the plurality of receptacles.

17. The floating filter system of claim 16, further comprising a movable under drain assembly in fluid communication with an outlet of the collection channel and configured to remove fluid from the collection channel.

18. The floating capillary filter system of claim 11, further comprising a cap configured to cover the inlet of the receptacle.

19. The floating capillary filter of claim 11, further comprising a plurality of floatation devices.

20. A system for filtering a body of water, the system comprising:
(a) one or more partitions configured to at least partially separate a first portion of the body of water from a second portion of the body of water;
(b) a pump configured to pump water from the first portion of the body of water and to provide the pumped water to the second portion of the body of water;
(c) a treatment component configured to add a coagulant and/or flocculent to the water pumped from the first portion of the body of water before the pump provides the water to the second portion of the body of water; and
(d) a floating filter system configured to float on a surface of the second body of water and to filter the second body of water via capillary action.
